(19) United States
(12) Patent Application Publication
(10) Pub. No.: US 2009/0086183 A1
(43) Pub. Date: Apr. 2, 2009

(54) EXPOSURE APPARATUS AND DEVICE MANUFACTURING METHOD

(75) Inventor: Yoshihiro Shiode, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/236,026

(22) Filed: Sep. 23, 2008

(30) Foreign Application Priority Data
Sep. 28, 2007 (JP) 2007-256004

(51) Int. Cl. G03B 27/54

(52) U.S. Cl. 355/67

(57) ABSTRACT

An exposure apparatus includes a calculating unit which calculates information representing the optical characteristic of the projection optical system, based on the relationship between the amount of defocus from the image plane of the projection optical system and the position of an image formed by the projection optical system.

### BACKGROUND OF THE INVENTION

1. Field of the Invention

The present invention relates to an exposure apparatus and a device manufacturing method.

2. Description of the Related Art

Along with advances in the micropatterning of devices such as a semiconductor device, a demand has arisen for increasing the NA (NA: numerical aperture) of a projection optical system of an exposure apparatus. Along with an increase in numerical aperture, it is becoming important to match the numerical aperture between exposure apparatuses, so needs for high-precision numerical aperture measurement and numerical aperture adjustment are increasing. Japanese Patent Laid-Open No. 2005-322856 discloses a method of measuring a light intensity distribution corresponding to the light intensity at the position of an aperture stop of a projection optical system on the basis of light having passed through the aperture stop, and calculating the numerical aperture from the measured light intensity distribution.

It is also demanded that an illumination system have a higher σ and form specific effective light source distributions optimized for various devices. An increase in numerical aperture requires polarized illumination optimization to cope with an increase in the reflectance of a photosensitive agent. This makes it necessary to precisely form effective light source distributions in various polarization states. For this purpose, it is indispensable to measure the effective light source distribution with high precision. U.S. Pat. No. 6,741,338 discloses a method of obtaining the intensity distribution of an effective light source on the basis of a pattern obtained by projecting the effective light source onto a wafer to expose the wafer while changing the exposure amount, and developing it.

Japanese Patent Laid-Open No. 2005-322856 and U.S. Pat. No. 6,741,338 neither disclose nor suggest a method of obtaining the optical characteristics of the projection optical system or illumination system on the basis of the relationship between the amount of defocus from the image plane of the projection optical system or the amount of aberration of the projection optical system, and the position of an image formed by the projection optical system.

### SUMMARY OF THE INVENTION

The present invention has been made in consideration of the above-described situation, and has as its object to provide a novel, useful technique for measuring the optical characteristics of a projection optical system or illumination system.

According to the first aspect of the present invention, there is provided an exposure apparatus which projects a pattern of a reticle onto a substrate by a projection optical system, thereby exposing the substrate, comprising:

a calculating unit configured to calculate information representing an optical characteristic of the projection optical system, based on a relationship between an amount of defocus from an image plane of the projection optical system and a position of an image formed by the projection optical system.

According to the second aspect of the present invention, there is provided an exposure apparatus which projects a pattern of a reticle onto a substrate by a projection optical system, thereby exposing the substrate, comprising:

a calculating unit configured to calculate information representing an optical characteristic of the projection optical system, based on a relationship between an amount of defocus from an image plane of the projection optical system and a position of an image formed by the projection optical system.

According to the third aspect of the present invention, there is provided an exposure apparatus which illuminates a reticle by an illumination system, and projects a pattern of the reticle onto a substrate by a projection optical system, thereby exposing the substrate, comprising:

a calculating unit configured to calculate information representing an optical characteristic of the illumination system, based on a relationship between an amount of defocus from an image plane of the projection optical system and a position of an image formed by the projection optical system.

According to the fourth aspect of the present invention, there is provided an exposure apparatus which illuminates a reticle by an illumination system, and projects a pattern of the reticle onto a substrate by a projection optical system, thereby exposing the substrate, comprising:

a calculating unit configured to calculate information representing an optical characteristic of the illumination system, based on a relationship between an amount of aberration of the projection optical system and a position of an image formed by the projection optical system.

According to the present invention, a novel, useful technique for measuring the optical characteristics of a projection optical system or illumination system is provided.

Further features of the present invention will become apparent from the following description of exemplary embodiments (with reference to the attached drawings).

### BRIEF DESCRIPTION OF THE DRAWINGS

FIG. 1 is a conceptual view for explaining the principle of the present invention;

FIG. 2 is a graph showing the relationship between the NA and the tilt of the primary ray;

FIG. 3 is a view schematically showing an exposure apparatus according to an exemplary embodiment of the present invention;

FIG. 4 is a view showing an example of a measurement mask;

FIG. 5 is a view showing another example of the measurement mask;

FIGS. 6A and 6B are views each showing an example of a measurement mark;

FIG. 7 is a view showing an example of a measurement mark;

FIG. 8 is a graph showing an example of a detection signal;

FIG. 9 is a graph showing an example of the tilt;

FIG. 10 is a flowchart schematically illustrating the sequence of processing controlled by a calculating unit;

FIG. 11 is a view showing an example of an opening;

FIG. 12 is a view showing the pupil of a projection optical system;

FIG. 13 is a view showing the pupil of the projection optical system;

FIG. 14 is a view showing another example of the opening of the measurement mask;

FIG. 15 is a view showing an example of the measurement mask;

FIG. 16 is a flowchart illustrating the procedure of a method of measuring the numerical aperture of a projection optical system by transferring a mark onto a substrate;

FIG. 17 is a view showing an example of a phase shift mask;

FIG. 18 is a view showing another example of the phase shift mask;

FIG. 19 is a view showing an example of a measurement mark;

FIG. 20 is a view showing an example of a mark formed on a wafer;

FIG. 21 is a view showing an example of mark groups;

FIG. 22 is an explanatory view of a measurement mask;

FIG. 23 is a flowchart illustrating the procedure of a method of measuring the numerical aperture of a projection optical system using a phase shift mask as the measurement mask;

FIG. 24 is a view showing an example of a measurement mask;

FIG. 25 is a graph showing the relationship between the tilt and the effective light source size;

FIG. 26 is a view showing the pupil of a projection optical system; and

FIG. 27 is a flowchart schematically illustrating the sequence of processing controlled by a calculating unit.

### DESCRIPTION OF THE EMBODIMENTS

Preferred embodiments of the present invention will be described below with reference to the accompanying drawings.

### First Embodiment

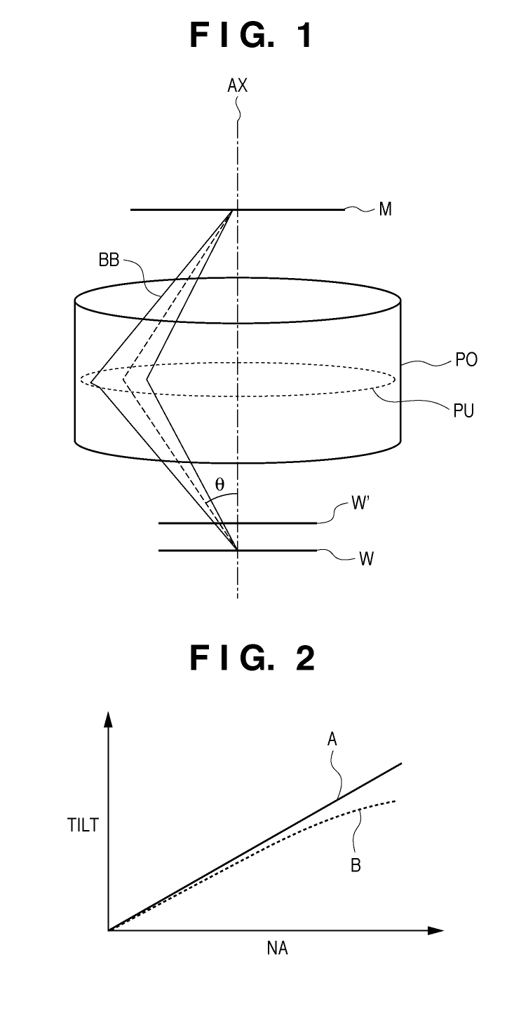

FIG. 1 is a conceptual view for explaining the principle of the present invention. A light beam BB emanating from one point on a mask M obliquely with respect to an optical axis AX passes through only a certain partial region (pupil PU) on the pupil plane in a projection optical system PO, and forms an image at one point on an image plane W. The amount of a positional shift of an image from a predetermined position (e.g., the optical axis AX) on the image plane W, and that of an image from the predetermined position on a plane W′ defined by defocusing the image plane W along the optical axis AX change depending on an incident angle θ of the primary ray of the light beam BB. By measuring the amounts of positional shifts of images from the predetermined position on a plurality of different planes parallel to the image plane W, and calculating a change in the amount of a positional shift with respect to the amount of a positional change in the optical-axis direction (slope), pieces of information representing the optical characteristics of the projection optical system PO can be obtained. Examples of the optical characteristics of the projection optical system PO are the numerical aperture of the projection optical system PO (the size of the pupil PU), and the shape of the pupil PU of the projection optical system PO.

The tilt of the primary ray herein corresponds to tan θ, while the numerical aperture of the projection optical system PO in the atmosphere corresponds to sin θ. The NA and the tilt of the primary ray therefore have a relationship expressed by tan θ and sin θ. A curve A shown in FIG. 2 represents the relationship between the NA and the tilt of the primary ray. Note that an actual light beam BB has a certain width. A certain component of the light beam BB which enters the projection optical system PO at an incident angle θ equal to or larger than a given angle is eclipsed by an aperture stop which defines the pupil PU of the projection optical system PO. For this reason, the tilt of the actual primary ray BB is smaller than that of the curve A. A curve B shown in FIG. 2 indicates the tilt of the actual primary ray BB.

This relationship can be obtained experimentally or by optical simulation. By measuring the tilt of the primary ray BB from the relationship between a pre-calculated tilt of the primary ray BB and the size of the pupil PU of the projection optical system PO, the size of the pupil PU of the projection optical system PO, that is, the numerical aperture of the projection optical system, PO can be calculated.

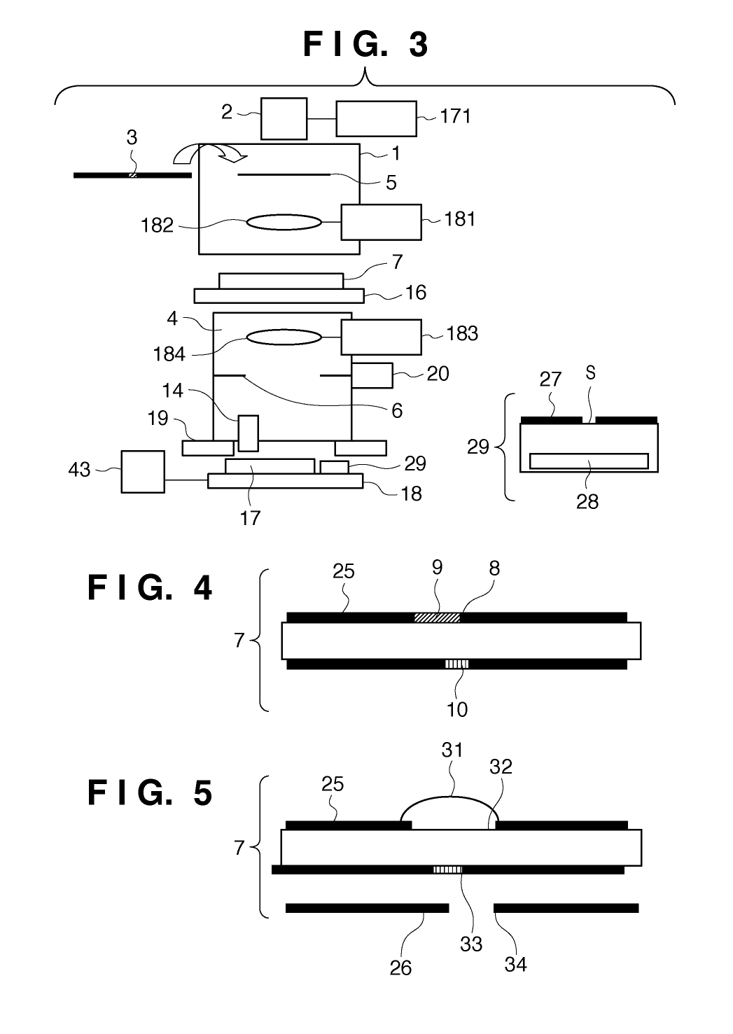

FIG. 3 is a view schematically showing an exposure apparatus according to an exemplary embodiment of the present invention. The exposure apparatus is configured to expose a wafer (substrate) held by a wafer chuck 17. More specifically, the exposure apparatus illuminates, by an illumination system 1, a reticle held by a reticle stage 16, and projects the pattern of the reticle onto a wafer by a projection optical system 4, thereby exposing the wafer.

The numerical aperture measurement function of the projection optical system 4 as an additional function of the exposure apparatus will be explained. The illumination system 1 which illuminates a reticle (original) using light emitted by a light source 2 has an aperture plate 5 placed at a position conjugate to the pupil plane of the projection optical system 4. If the numerical aperture of the illumination system 1 is insufficient to supply the light by diverging it up to the size of the aperture stop of the projection optical system 4, the aperture plate 5 can be replaced by an aperture plate 3 having an optical element which exhibits the diffusion effect. The aperture plate 3 may be substituted by an optical member such as a CGH (Computer Generated Hologram), which can form an effective light source shape best suited to measure the numerical aperture of the projection optical system 4.

Light emitted by the illumination system 1 illuminates a measurement mask 7 held by the reticle stage 16. As exemplified in FIG. 4, the measurement mask 7 has a light-shielding film 25 on its surface (lower surface) opposite to the object plane (pattern surface). An opening 8 is formed in the light-shielding film 25. A diffusing optical element 9 is set on the upper portion or inside of the opening 8. The diffusing optical element 9 produces the same effect as that of the aperture plate 3 having an optical element which exhibits the diffusion effect described above.

In this embodiment, the numerical aperture of the projection optical system 4 is measured by obliquely irradiating the image plane of the projection optical system 4 with a light beam in a region including a stop boundary which defines the pupil PU of the projection optical system 4. Referring to FIG. 12, the outer boundary of the light beam used for numerical aperture measurement matches an illumination aperture boundary R defined on the outside of a stop boundary NAR on the pupil plane of the projection optical system 4. The light beam used for numerical aperture measurement must obliquely enter the projection optical system 4. For example, a light beam which passes through each divided region obtained by dividing a region surrounded by the illumination aperture boundary R into four by two lines K which pass through a pupil center C can be used as the light beam used for numerical aperture measurement. Although FIG. 12 exemplifies a case in which a light beam which passes through each divided region DR obtained by dividing a region surrounded by the illumination aperture boundary R into four is used as the light beam used for numerical aperture measurement, the division method is not particularly limited to this. For example, the division number may be a plural number other than four. In FIG. 12, reference symbol C indicates the pupil center of the projection optical system 4.

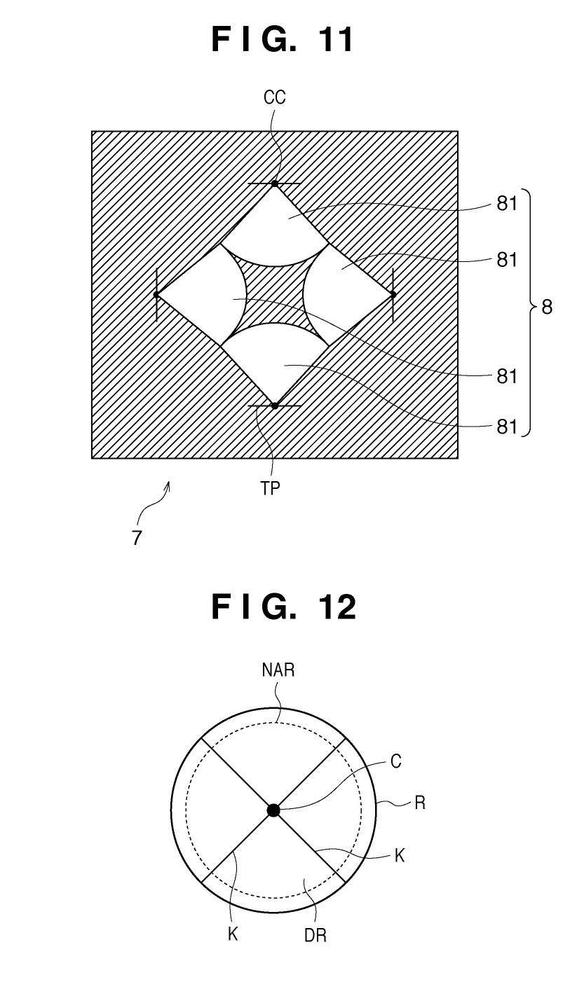

FIG. 11 is a view showing an example of the opening 8 formed in the lower source of the measurement mask 7. In this example, the opening 8 includes four partial openings 81. A light beam which passes through one partial opening 81 corresponds to one divided region explained with reference to FIG. 12.

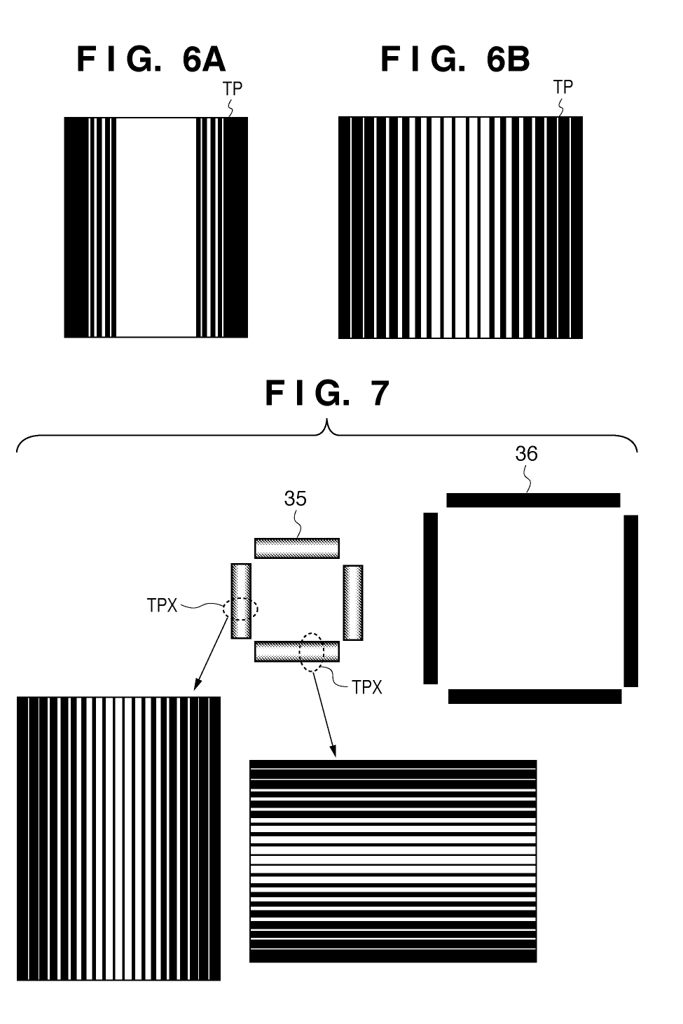

A measurement mark 10 formed on the pattern surface of the measurement mask 7 is obtained by arranging a mark TP exemplified in FIG. 6A or 6B at a position corresponding to each partial opening 81. Each mark TP is arranged at a position immediately below a reference point CC. The mark TP can be formed from, for example, a periodical pattern in which the pitch (interval) between lines or spaces is nearly constant and the widths of individual spaces through which light beams pass decrease from the pattern element of the central line or central space of the periodical pattern toward the outer pattern element. Alternatively, the mark TP can be the one obtained by forming fine lines at the two edge portions of a line with a certain width. The mark TP is a pattern which exhibits the effect of reducing high-order diffracted light beams, and its use allows an increase in the measurement precision. The light intensity distribution of a pattern image obtained by imaging the mark TP via the projection optical system assuming the mark TP as one line can be said to be one large pattern in which the interval between lines is not resolved and which has small distortions. This allows high-precision positional shift measurement. International Publication WO 03/021352 (U.S. Pat. No. 7,190,443) describes details of such a mark (pattern).

The orientations of the marks TP in the rotation direction on the X-Y plane will be explained. The marks TP arranged at positions corresponding to two horizontal partial openings 81 shown in FIG. 11 are oriented along the same direction as that shown in FIGS. 6A and 6B (a direction along which lines extend vertically). In contrast, the marks TP arranged at positions corresponding to two vertical partial openings 81 shown in FIG. 11 are oriented along a direction defined by rotating the marks TP shown in FIGS. 6A and 6B through 90° (horizontal direction). With this setting, when a light beam having passed through the partial opening 81 passes through the mark TP, it reaches the image plane of the projection optical system 4 upon passing through a corresponding one of the four divided regions DR (see FIG. 12) on the pupil plane of the projection optical system 4 (as long as diffraction is neglected).

The mark TP of the measurement mark 10 can be a line & space pattern, as exemplified in FIGS. 6A and 6B. The mark TP can be various patterns.

With the above-described arrangement, an image of the measurement mark 10 (mark TP) is formed on the surface of a light-shielding member 27 of a detecting unit 29 arranged on a wafer stage (substrate stage) 18 by the projection optical system 4. The light-shielding member 27 has a slit (opening) S, and a sensor 28 detects light which has passed through the slit S. The sensor 28 detects, for example, the intensity or amount of incident light, and outputs the detection result.

First, the position of the wafer stage 18 in the Z direction (the optical-axis direction of the projection optical system 4) is adjusted so that the image plane of the projection optical system 4 matches the surface of the detecting unit 29. At this time, a focus measuring unit 19 measures the surface position of the detecting unit 29. The wafer stage 18 can be driven based on the measurement result.

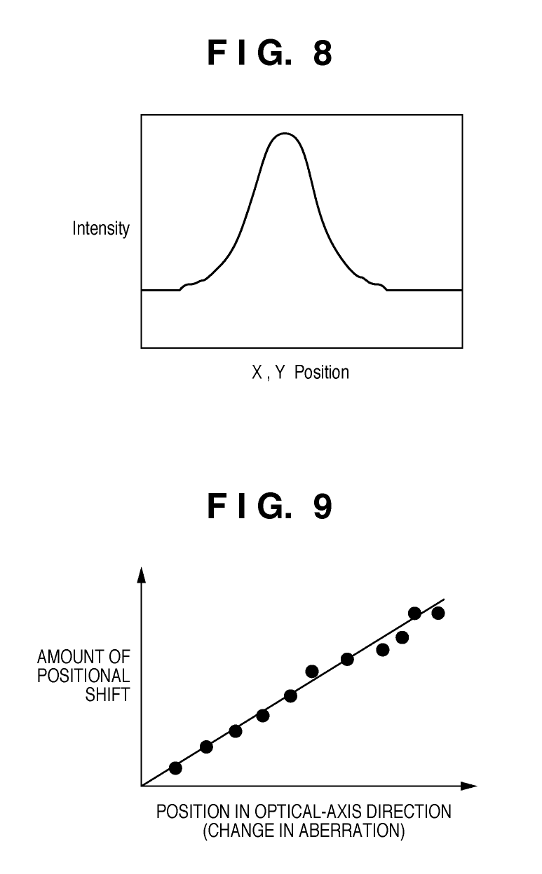

Next, the sensor 28 detects light which has passed through the slit S while moving the wafer stage 18 in a direction perpendicular to the lines of the mark TP (measurement mark 10) on a plane (X and Y directions) perpendicular to the optical-axis direction of the projection optical system 4 (Z direction). Based on the position of the wafer stage 18 in the X direction (or Y direction) at this time, and the output (e.g., the light intensity) from the sensor 28, a detection signal as exemplified in FIG. 8 is obtained. In the example shown in FIG. 8, the ordinate indicates the light intensity (Intensity), and the abscissa indicates the position of the detecting unit 29 (wafer stage) in the X direction or Y direction (X, Y Position). Based on this detection signal, a calculating unit 43 detects the central position of an image of the mark TP (measurement mark 10).

The width of the slit S is desirably less than or equal to the half of the width of an aerial image (peak portion) exemplified in FIG. 8. As exemplified in FIGS. 6A and 6B, increasing the number of lines of the mark TP and that of slits S correspondingly makes it possible to increase the amount of light which enters the sensor 28 and to improve the detection precision by the averaging effect. To switch the direction of the slit S in accordance with the direction of the lines of the mark TP (whether the mark TP has vertical lines or horizontal lines), a slit S and sensor 28 for vertical lines and a slit S and sensor 28 for horizontal lines can be provided.

The wafer stage 18 is moved in the Z direction (the optical-axis direction of the projection optical system 4). At a predetermined defocus position, the sensor 28 detects light which passes though the slit S in the above-described way while similarly moving the wafer stage 18 in the X and Y directions. With this operation, a detection signal as exemplified in FIG. 8 is obtained. Based on this detection signal, the central position of an image of the mark TP (measurement mark 10) is detected.

As exemplified in FIG. 9, the calculating unit 43 obtains a characteristic curve representing the relationship between the position of the detecting unit 29 in the optical-axis direction of the projection optical system 4 (the amount of defocus), and the amount of a shift of the central position of the image of the mark TP (measurement mark 10) (the amount of a positional shift). The amount of a shift herein means the amount of a shift from a predetermined reference position. The reference position can be, for example, the optical axis or the central position of the image of the mark TP (measurement mark 10) when the surface of the detecting unit 29 is positioned on the image plane of the projection optical system 4. Instead of detecting the amount of a positional shift at each of a plurality of different defocus positions (positions in the optical-axis direction), the amount of a positional shift may be detected for each amount of aberration by changing the amount of aberration of the projection optical system 4 by driving a correction optical system 184 in the projection optical system 4 by a driving mechanism 183. Alternatively, the amount of a positional shift may be detected for each amount of aberration by changing the amount of aberration by changing, by a wavelength controller 171, the wavelength of light emitted by the light source 2. The aberration of the projection optical system 4 can be, for example, spherical aberration, astigmatism, or coma.

The calculating unit 43 calculates a slope m of a characteristic curve as exemplified in FIG. 9. For example, the calculating unit 43 approximates the characteristic curve by a straight line, and calculates its slope m. The calculating unit 43 then calculates a numerical aperture value corresponding to the calculated slope m as information representing the optical characteristic of the projection optical system 4, based on the relationship between the NA and the tilt exemplified in FIG. 2. The relationship between the NA and the tilt exemplified in FIG. 2 can be pre-registered in the calculating unit 43 as a table or approximation. Executing the above-described processing for the four marks TP makes it possible to obtain the pupil shape of the projection optical system 4 as information representing the optical characteristic of the projection optical system 4.

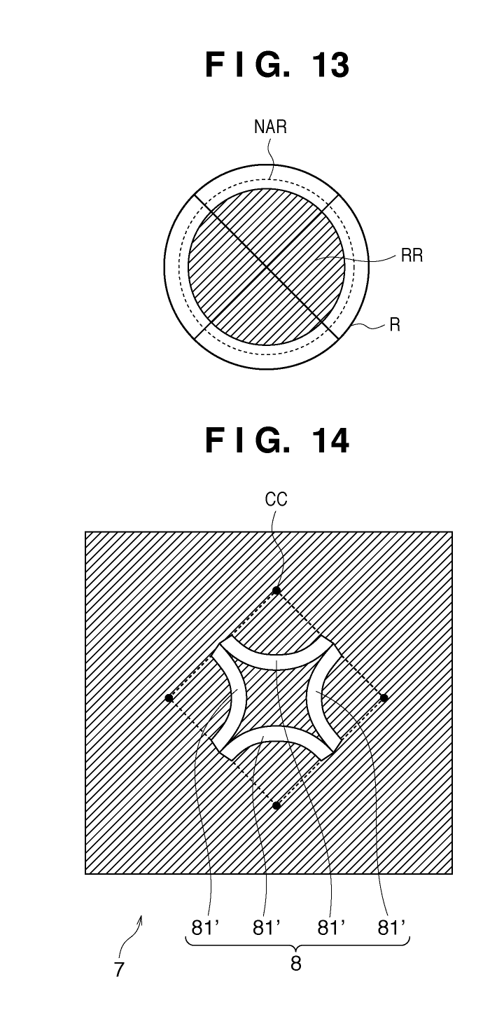

As exemplified in FIG. 13, the slope m of the characteristic curve can be increased by providing a light-shielded region RR on the pupil of the projection optical system 4, and passing only light near the stop boundary NAR through it. The larger the slope m, the higher the sensitivity. This makes it possible to calculate the optical characteristics of the projection optical system 4 with high precision.

FIG. 14 shows a method of providing the light-shielded region RR. FIG. 14 shows another arrangement example of the opening 8 formed in the lower surface of the measurement mask 7. In the arrangement example shown in FIG. 14, the opening 8 has four arcuated partial openings 81′. Even when an arrangement using the partial openings 81′ is adopted, each mark TP is arranged at a position immediately below the reference point CC, as in the arrangement example shown in FIG. 11.

The calculating unit 43 controls processing associated with the above-described measurement such as the driving of the wafer stage 18 and the control of the detecting unit 29. The calculating unit 43 can hold parameters such as the pupil transmittance distribution of the projection optical system 4 and the effective light source distribution upon illumination. These parameters can be taken into consideration in numerical aperture calculation. The calculating unit 43 can also calculate the numerical aperture in accordance with:

$$m = \frac{{\int }_{θ 1}^{θ 2} {\int }_{r 1}^{NA} S ( r , θ ) \cdot P ( r , θ ) \cdot M ( r , θ ) d r d θ}{{\int }_{θ 1}^{θ 2} {\int }_{r 1}^{NA} S ( r , θ ) \cdot P ( r , θ ) d r d θ} \qquad ( 1 )$$

where m is the measured slope, r and θ are the polar coordinates on the pupil plane, S(r,θ) is the effective light source distribution, P(r,θ) is the pupil transmittance distribution, M(r,θ) is the theoretical slope, θ1 and θ2 define the illumination region on the pupil in the rotation direction, and r1 and NA define the illumination region on the pupil in the radial direction.

Based on the numerical aperture measurement result, the calculating unit 43 can adjust the numerical aperture of the projection optical system 4 by controlling a stop driving unit 20 which drives an NA stop (a stop which defines the pupil) of the projection optical system 4.

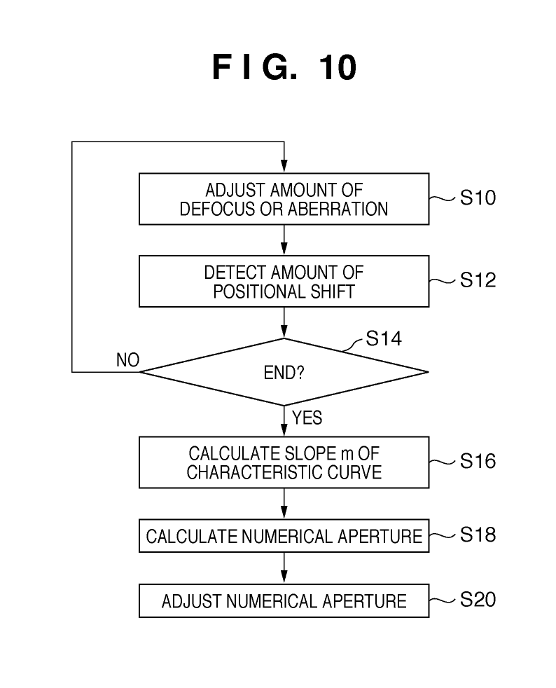

FIG. 10 is a flowchart schematically illustrating the sequence of the above-described processing controlled by the calculating unit 43. The calculating unit 43 may also be interpreted as a control unit or processing unit. In step S10, the calculating unit 43 adjusts the amount of defocus or aberration. The amount of defocus can be adjusted by driving the wafer stage 18 in the optical-axis direction of the projection optical system 4, as described above. The amount of aberration can be adjusted by driving the correction optical system 184 by the driving mechanism 183 or by changing, by the wavelength controller 171, the wavelength of light emitted by the light source 2, as described above.

In step S12, the calculating unit 43 detects the amount of a positional shift of the image of the mark TP by the detecting unit 29. In step S14, the calculating unit 43 determines whether the processing operations in steps S10 and S12 have been executed a set number of times. If YES in step S14, the process advances to step S16. If NO in step S14, the process returns to step S10.

In step S16, the calculating unit 43 calculates the slope m of the characteristic curve exemplified in FIG. 9, which is obtained by repeating the processing operations in steps S10 and S12. In step S18, the calculating unit 43 calculates a numerical aperture value corresponding to the calculated slope m based on the relationship between the NA and the tilt exemplified in FIG. 2.

In step S20, based on the calculated numerical aperture value, the calculating unit 43 adjusts the numerical aperture of the projection optical system 4 by controlling the stop driving unit 20 which drives the stop of the projection optical system 4.

The above-described method measures an aerial image of a measurement mark formed by the projection optical system 4. In place of this method, a method of transferring the measurement mark onto a substrate by exposure and measuring the position of the mark formed on the substrate may be adopted.

In this case, a measurement mark 35 as exemplified in FIG. 7 can be used for the measurement mask 7. The measurement mark 35 can have, for example, a frame shape. A bar of one side of the frame can be formed from a pattern including a plurality of lines as exemplified in FIG. 6A or 6B. The use of such a measurement mark 35 with a frame shape allows measurement of positional shifts in either of the X and Y directions. However, in accordance with the direction in which a positional shift is measured, a mark including only vertical lines as shown in FIG. 6A or 6B may be used, or that including only horizontal lines, which is obtained by rotating that mark through 90°, may be used.

A reference mark 36 can be formed in a region different from the measurement mark 35 on the pattern surface of the measurement mask 7. An opening is formed in a portion opposing the reference mark 36 on the lower surface of the measurement mask 7.

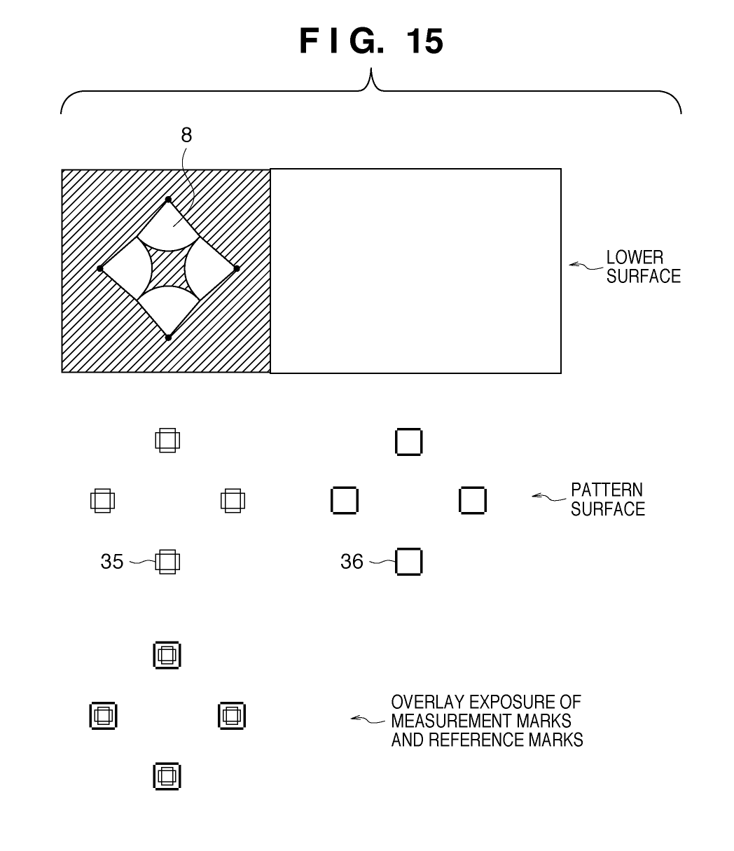

The reference mark 36 is used to measure a positional shift relative to the measurement mark 35, and has an arbitrary shape. For example, a measurement mark 35 which includes lines having a line width of 2 μm, and a reference mark 36 having a size different from that of the measurement mark 35 can be used. FIG. 15 shows an arrangement example of the measurement mark and reference mark.

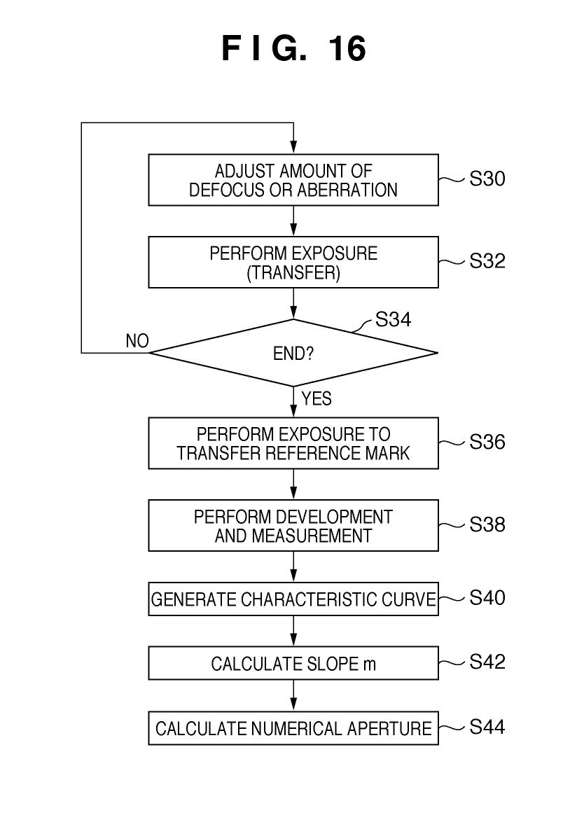

FIG. 16 is a flowchart illustrating the procedure of a method of measuring the numerical aperture of the projection optical system by transferring a mark onto a substrate. In step S30, the amount of defocus or aberration is adjusted. In step S32, the measurement mark 35 is transferred by exposure onto a photosensitive agent applied on a substrate (i.e., an image of the measurement mark 35 is formed on a photosensitive agent as a latent image). Prior to the execution of the processing operation in step S32 for the second and subsequent times, the wafer stage 18 is driven in the X and Y directions to change the exposure region on the substrate. In step S34, it is determined whether the processing operations in steps S30 and S32 have been executed a set number of times. If YES in step S34, the process advances to step S36. If NO in step S34, the process returns to step S30.

In step S36, after the amount of defocus or aberration is adjusted to a reference value, the reference mark 36 is transferred onto the substrate by exposure so as to match a latent image of each measurement mark 35 transferred.

In step S38, the latent image formed on the photosensitive agent on the substrate by exposure is developed. Then, positional shifts of the images of all the measurement marks 35, which are transferred under a plurality of conditions with regard to the amount of defocus or aberration, with respect to the image of the reference mark 36 are measured.

In step S40, a characteristic curve exemplified in FIG. 9 is generated based on the measurement result obtained in step S38. In step S42, a slope m of the characteristic curve is calculated. In step S44, a numerical aperture value corresponding to the calculated slope m is calculated based on the relationship between the NA and the tilt exemplified in FIG. 2.

Although the measurement is performed after developing the latent image in the processing shown in FIG. 16, the position of the latent image formed on the photosensitive agent may be measured. For example, the mark may be transferred onto a substrate made of a photochromic material to form a latent image on it, thereby detecting the position of the latent image by an off-axis alignment detection system 14 of the exposure apparatus. The position of the latent image can also be measured.

By setting units as exemplified in FIG. 11 or 14 at several points on the same measurement mask 7, the numerical aperture can be measured for each image height by exposure according to the above-described method.

### Second Embodiment

This embodiment provides another arrangement example of the measurement mask. FIG. 5 is a view showing the arrangement of a measurement mask according to the second embodiment of the present invention. A measurement mask 7 has a light-shielding film 25 on its lower surface (upper surface; a surface on the side of an illumination system). An opening 32 is formed in the light-shielding film 25. A diffusing optical element 31 is set in or above the opening 32.

A measurement mark 33 is formed on the pattern surface of the measurement mask 7. A light-shielding member 26 having an opening 34 at its central position shifted from the central position of the measurement mark 33 is set below the measurement mark 33 (on the side of a projection optical system).

The opening 32 and diffusing optical element 31 supply a light beam to the measurement mark 33, which is formed on the pattern surface, at an incident angle enough to satisfy σ>1. The measurement mark 33 can include, for example, a mark exemplified in FIG. 6A, 6B, or 7. The opening 34 can have a shape exemplified in FIG. 11 or 14. When a light beam having passed through the measurement mark 33 passes the opening 34, it is guided to a region on the inside of a illumination aperture boundary R shown in FIG. 12 or that near a stop boundary NAR shown in FIG. 13.

By setting units as exemplified in FIG. 5 in a plurality of regions at the same image height, the pupil shape of the projection optical system 4 can be measured.

### Third Embodiment

This embodiment provides still another arrangement example of the measurement mask. In this embodiment, a phase shift mask (PSG; Phase Shift Grating) is used as the measurement mask.

The phase shift mask is described in Japanese Patent Laid-Open No. 2002-55435. This patent reference describes a method of calculating the optical characteristics of an optical system by measuring the phase difference between portions through which light beams at two points which exhibit different wavefronts propagate, using two-beam interference.

More specifically, a space portion (transparent portion) of a line & space mark on a phase shift mask shown in FIG. 18 is formed by two different steps so that the phase difference between light beams which propagate through the two different steps becomes 90°.

When the line & space mark is illuminated by normal low-σ illumination, two-beam interference between the 0th-order diffracted light beam and the +1st- or −1st-order diffracted light beam occurs, unlike three-beam interference among the 0th- and ±1st-order diffracted light beams on a line & space mark using a general binary mask. Note that the pitch of the line & space mark is determined such that the +1st- or −1st-order diffracted light beam passes through an NA stop of a projection optical system 4, but other high-order diffracted light beams are eclipsed by the NA stop of the projection optical system 4 and do not form an image.

When the projection optical system 4 has wavefront aberration, an image formed on the image plane by the two-beam interference comes under the influence of a phase difference that occurs between the portions through which the two light beams propagate. The position of the image formed on the image plane shifts due to this phase difference. Hence, the phase difference can be calculated by detecting a positional shift of this image and the portions through which the two light beams propagate.

Changing the pitch of the line & space mark or rotating the mark makes it possible to control the traveling direction of diffracted light. In other words, these settings allow arbitrary control of the portions through which the two light beams propagate.

FIG. 19 is a view showing a mark for measuring a phase shift. By overlay exposure (trim exposure) of a substrate using a mark 200 and mark (trim pattern) 201 shown in FIG. 19, a Box to Box shape in which part of the mark 200 remains as exemplified in FIG. 20 is obtained. In the Box to Box shape, a measuring device measures a positional shift between the inner Box and the outer Box. Japanese Patent Laid-Open No. 2002-55435 describes details of the Box mark.

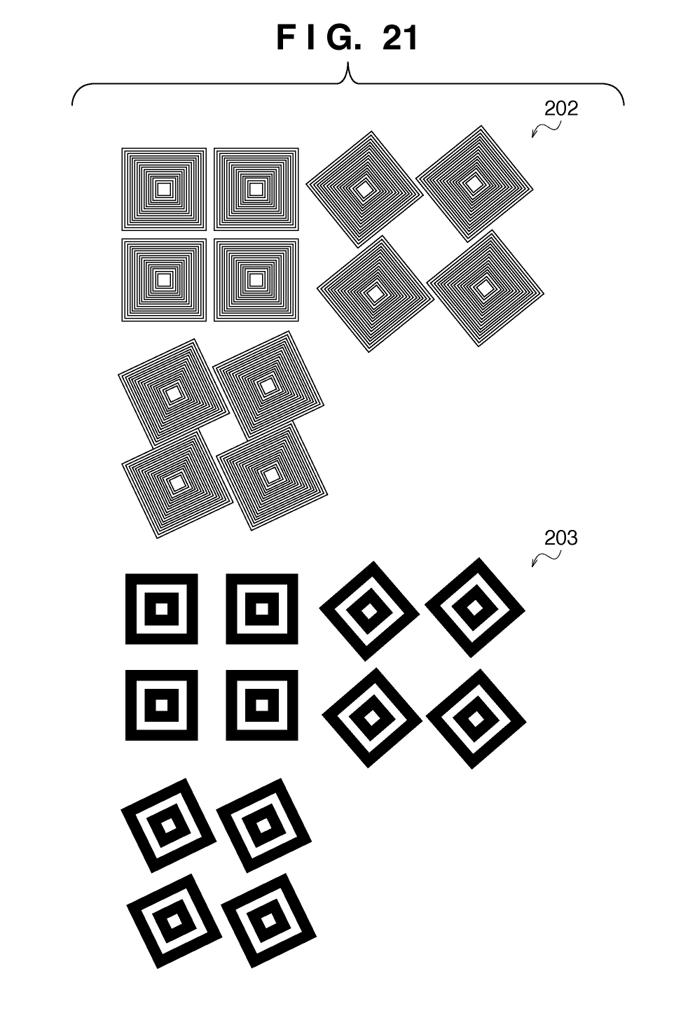

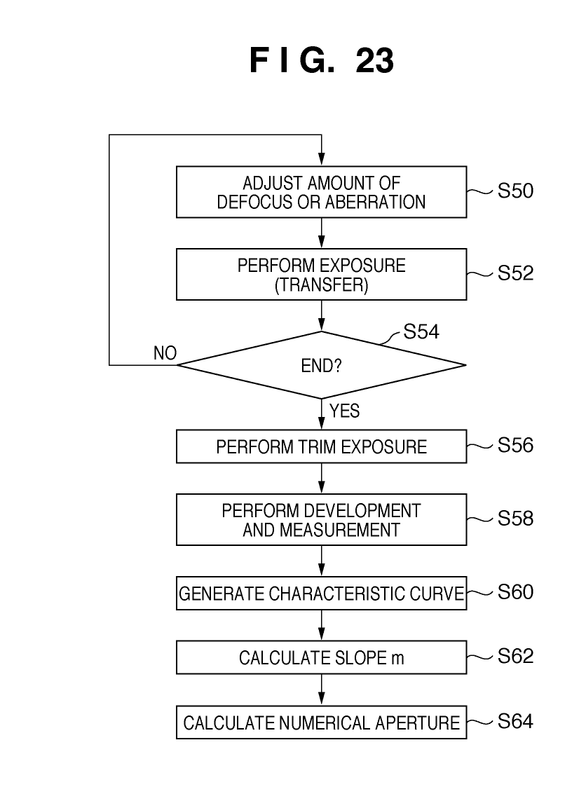

A detailed example of the above-described measurement method will be explained. FIG. 23 is a flowchart illustrating the procedure of a method of measuring the numerical aperture of the projection optical system using a phase shift mask as the measurement mask. First, in step S50, the amount of defocus or aberration is adjusted. In step S52, a mark group 202 shown in FIG. 21 is transferred by low-σ illumination onto a photosensitive agent applied on a substrate. Prior to the execution of the processing operation in step S32 for the second and subsequent times, a wafer stage 18 is driven in the X and Y directions to change the exposure region on the substrate.

Referring to FIG. 21, mark groups 202 are obtained by arranging marks 200 in regions at the same image height at various array pitches and in various rotation directions. A mark group 203 is obtained by arranging marks (trim patterns) 201 such that their positions and rotation directions match those of the marks of the mark group 202.

In step S54, it is determined whether the processing operations in steps S50 and S52 have been executed a set number of times. If YES in step S54, the process advances to step S56. If NO in step S54, the process returns to step S50.

In step S56, the wafer stage 18 or a reticle stage 16 is driven so that a latent image of the mark 200 of the mark group 202 matches an image of the mark (trim pattern) 201 of the mark group 203. Then, the mark group 203 is transferred onto the substrate by normal illumination.

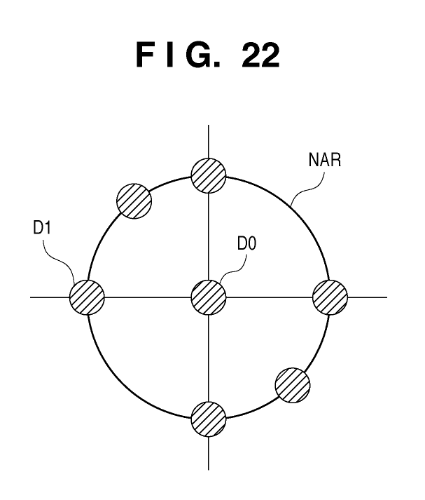

In step S58, the latent image formed on the photosensitive agent on the substrate by exposure is developed. A measuring device measures positional shifts between the inner Box and the outer Box of a mark transferred under a plurality of conditions with regard to the amount of defocus or aberration. As the mark to be measured, the one which scatters diffracted light to the vicinity of the NA stop on the pupil plane of the projection optical system, as shown in FIG. 22, is selected. The positional shift of the latent image may be measured without developing it.

In step S60, a characteristic curve exemplified in FIG. 9 is generated for each rotation direction based on the measurement result obtained in step S58. In step S62, a slope m of the characteristic curve is calculated for each rotation direction.

In step S62, a numerical aperture value corresponding to the slope m is calculated for each rotation direction based on the relationship between the NA and the tilt exemplified in FIG. 2. With this operation, the pupil shape (NA stop) of the projection optical system 4 is also determined.

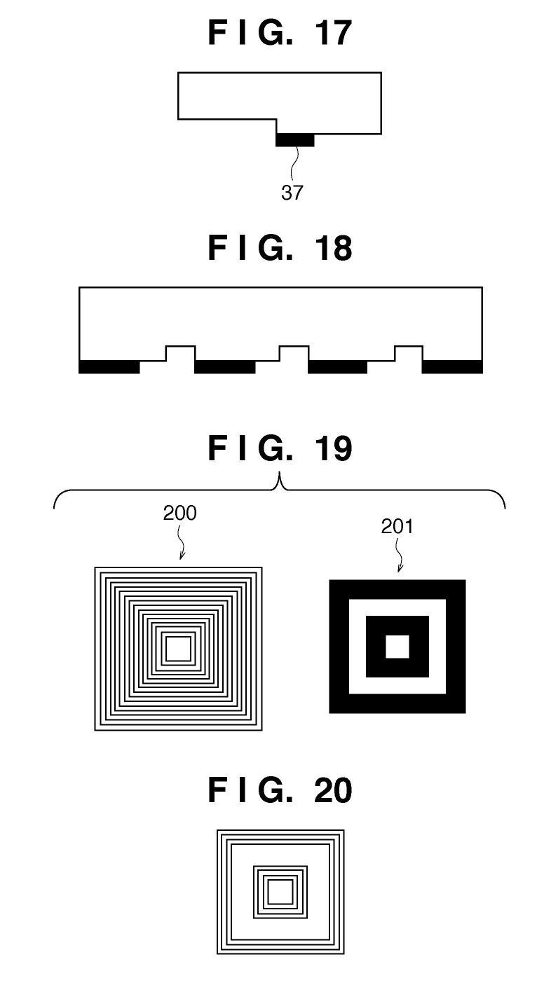

In place of the above-described mask, a phase shift mask (PSFM; Phase Shift Focus Monitor) having marks formed such that one line pattern (light-shielding line) shown in FIG. 17 has different left and right phases other than 0° and 180° can be used. The PSFM can be generally formed to generate a phase difference of 90°.

Like the PSG, the PSFM is commercially available as a focus monitor. Although the PSFM generates a positional shift with respect to aberration in principle as in the PSG, it uses one line (generally, a line width around the resolution limit is used) differently from two-beam interference by a grating. Hence, diffracted light spreading over the entire pupil plane of the projection optical system generates an image positional shift due to the influence of the average aberration of the entire wavefront, so the PSFM exhibits a relatively low sensitivity to the positional shift.

It is obvious that the use of the PSFM allows the same numerical aperture measurement as in the PSG, and a detailed description thereof will not be given.

### Fourth Embodiment

The measurement of the numerical aperture or pupil shape of the projection optical system has been explained above. The effective light source shape of an illumination system can be measured in the same way.

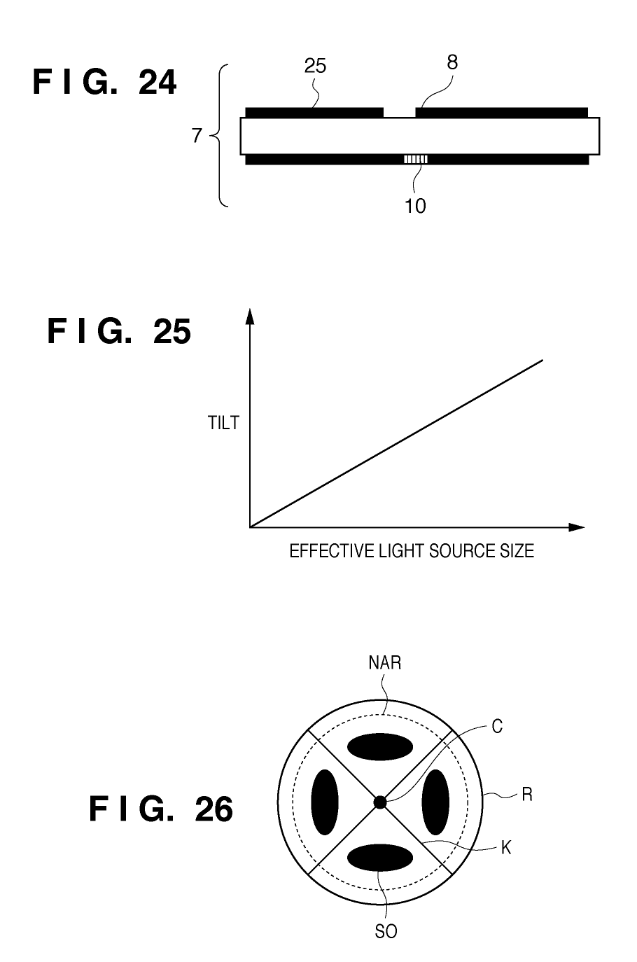

An exemplary embodiment will be explained with reference to FIG. 3. Light emitted by an illumination system 1 passes through a measurement mask 7 held by a reticle stage 16. The measurement mask 7 has a light-shielding film 25 which is provided on the surface opposite to the object plane and in which an opening 8 is formed, as shown in FIG. 24. As shown in FIG. 26, the size of an effective light source SO is smaller than a stop NAR of the projection optical system. The measurement of the effective light source does not require diverging illumination light beyond the stop NAR of the projection optical system, unlike the measurement of the numerical aperture or pupil shape of the projection optical system.

To form an image of a light beam by oblique incidence illumination, a light beam surrounded by a boundary R is divided into four by lines K which pass through a pupil center C. However, the division method is not particularly limited to this.

FIG. 11 shows a layout example in which four divided light beams shown in FIG. 26 are independently set at the positions of partial openings 81 formed in the lower surface of the measurement mask 7. However, the layout is not particularly limited to this as long as the light beams are set in regions at the same image height.

A mark TP (measurement mark 10) (FIGS. 6A and 6B) is formed on the pattern surface of the measurement mask 7 to correspond to each partial opening 81. Each mark TP is arranged at a position immediately below a reference point CC.

The orientations of the marks TP in the rotation direction on the X-Y plane are as follows. The marks TP arranged at positions corresponding to two horizontal partial openings 81 shown in FIG. 11 are oriented along the same direction as that shown in FIGS. 6A and 6B (a direction along which lines extend vertically). In contrast, the marks TP arranged at positions corresponding to two vertical partial openings 81 shown in FIG. 11 are oriented along a direction defined by rotating the marks TP shown in FIGS. 6A and 6B through 90° (horizontal direction). With this setting, when a light beam having passed through the partial opening 81 passes through the mark TP, it reaches the image plane of the projection optical system 4 upon passing through a corresponding one of the four divided regions DR (see FIG. 12) on the pupil plane of the projection optical system 4 (as long as diffraction is neglected).

With the above-described arrangement, an image of the measurement mark 10 (mark TP) is formed on the surface of a light-shielding member 27 of a detecting unit 29 arranged on a wafer stage (substrate stage) 18 by the projection optical system 4. The light-shielding member 27 has a slit (opening) S, and a sensor 28 detects light which has passed through the slit S.

First, the position of the wafer stage 18 in the Z direction (the optical-axis direction of the projection optical system 4) is adjusted so that the image plane of the projection optical system 4 matches the surface of the detecting unit 29. At this time, a focus measuring unit 19 measures the surface position of the detecting unit 29. The wafer stage 18 can be driven based on the measurement result.

Next, the sensor 28 detects light which has passed through the slit S while moving the wafer stage 18 in a direction perpendicular to the lines of the mark TP (measurement mark 10) on a plane (X and Y directions) perpendicular to the optical-axis direction of the projection optical system 4 (Z direction). Based on the position of the wafer stage 18 in the X direction (or Y direction) at this time, and the output (e.g., the light intensity) from the sensor 28, a detection signal as exemplified in FIG. 8 is obtained. In the example shown in FIG. 8, the ordinate indicates the light intensity, and the abscissa indicates the position of the detecting unit 29 (wafer stage) in the X direction or Y direction. Based on this detection signal, a calculating unit 43 detects the central position of an image of the mark TP (measurement mark 10).

The width of the slit S is desirably less than or equal to half of the width of an aerial image (peak portion) exemplified in FIG. 8. As exemplified in FIGS. 6A and 6B, increasing the number of lines of the mark TP and that of slits S correspondingly makes it possible to increase the amount of light which enters the sensor 28 and to improve the detection precision by the averaging effect. To switch the direction of the slit S in accordance with the direction of the lines of the mark TP (whether the mark TP has vertical lines or horizontal lines), a slit S and sensor 28 for vertical lines and a slit S and sensor 28 for horizontal lines can be provided.

The wafer stage 18 is moved in the Z direction (the optical-axis direction of the projection optical system 4). At a predetermined defocus position, the sensor 28 detects light which passes though the slit S in the above-described way while similarly moving the wafer stage 18 in the X and Y directions. With this operation, a detection signal as exemplified in FIG. 8 is obtained. Based on this detection signal, the central position of an image of the mark TP (measurement mark 10) is detected.

As exemplified in FIG. 9, the calculating unit 43 obtains a characteristic curve representing the relationship between the position of the detecting unit 29 in the optical-axis direction of the projection optical system 4 (the amount of defocus), and the amount of a shift of the central position of the image of the mark TP (measurement mark 10) (the amount of a positional shift). The amount of a shift herein means the amount of a shift from a predetermined reference position. The reference position can be, for example, the optical axis or the central position of the image of the mark TP (measurement mark 10) when the surface of the detecting unit 29 is positioned on the image plane of the projection optical system 4. Instead of detecting the amount of a positional shift at each of a plurality of different defocus positions (positions in the optical-axis direction), the amount of a positional shift may be detected for each amount of aberration by changing the amount of aberration of the projection optical system 4 by driving a correction optical system 184 in the projection optical system 4 by a driving mechanism 183. Alternatively, the amount of a positional shift may be detected for each amount of aberration by changing the amount of aberration by changing, by a wavelength controller 171, the wavelength of light emitted by the light source 2.

The calculating unit 43 calculates a slope m of a characteristic curve as exemplified in FIG. 9. For example, the calculating unit 43 approximates the characteristic curve by a straight line, and calculates its slope m.

The calculating unit 43 calculates an effective light source size corresponding to the calculated slope m based on the relationship between the effective light source size and the tilt exemplified in FIG. 25. The relationship between the effective light source size and the tilt exemplified in FIG. 25 can be pre-registered in the calculating unit 43 as a table or approximation.

The relationship between the effective light source size and the tilt exemplified in FIG. 25 will be explained herein. Like the numerical aperture measurement, the effective light source and the tilt can be said to have a relationship expressed by tan θ and sin θ. Therefore, the tilt obtained by measuring the effective light source size is that of the primary ray of light beams obtained by dividing a light beam from the effective light source of an illumination system, that is, the effective size of the effective light source.

Executing the above-described processing for the four marks TP makes it possible to measure even the effective shape of the effective light source.

The calculating unit 43 controls processing associated with the above-described measurement such as the driving of the wafer stage 18 and the control of the detecting unit 29. The calculating unit 43 can also calculate the effective light source size in accordance with:

$$m = \frac{{\int }_{θ 1}^{θ 2} {\int }_{r 1}^{r 2} P ( r , θ ) \cdot M ( r , θ ) d r d θ}{{\int }_{θ 1}^{θ 2} {\int }_{r 1}^{NA} P ( r , θ ) d r d θ} \qquad ( 2 )$$

where m is the measured slope, r and θ are the polar coordinates on the pupil plane, P(r,θ) is the pupil transmittance distribution, M(r,θ) is the theoretical slope, θ1 and θ2 define the effective light source region designed on the pupil in the rotation direction, and r1 and NA define the effective light source region designed on the pupil in the radial direction. Note that the calculating unit 43 can also calculate the outermost contour using r2 as a parameter.

The calculating unit 43 can hold parameters such as the pupil transmittance distribution of the projection optical system 4 and the effective light source distribution upon illumination. These parameters can be taken into consideration in numerical aperture calculation. Furthermore, the calculating unit 43 can adjust the effective light source from the calculated effective light source size by driving a correction optical system 182 in the illumination system 1 by a driving mechanism 181.

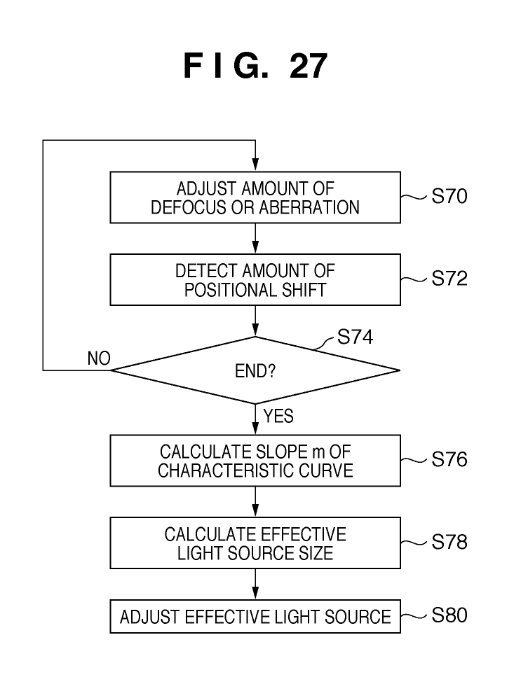

FIG. 27 is a flowchart schematically illustrating the sequence of the above-described processing controlled by the calculating unit 43. In step S70, the calculating unit 43 adjusts the amount of defocus or aberration. The amount of defocus can be adjusted by driving the wafer stage 18 in the optical-axis direction of the projection optical system 4, as described above. The amount of aberration can be adjusted by driving the correction optical system 184 by the driving mechanism 183 or by changing, by the wavelength controller 171, the wavelength of light emitted by the light source 2, as described above.

In step S72, the calculating unit 43 detects the amount of a positional shift of the image of the mark TP by the detecting unit 29. In step S74, the calculating unit 43 determines whether the processing operations in steps S70 and S72 have been executed a set number of times. If YES in step S74, the process advances to step S76. If NO in step S74, the process returns to step S70.

In step S76, the calculating unit 43 calculates the slope m of the characteristic curve exemplified in FIG. 9, which is obtained by repeating the processing operations in steps S70 and S72. In step S78, the calculating unit 43 calculates an effective light source size corresponding to the calculated slope m as information representing the optical characteristic of the illumination system, based on the relationship between the effective light source size and the tilt exemplified in FIG. 25.

In step S80, the calculating unit 43 can adjust the effective light source by driving the correction optical system 182 in the illumination system 1 by the driving mechanism 181 based on the calculated effective light source size.

The above-described method measures an aerial image of a measurement mark formed by the projection optical system 4. In place of this method, a latent image of the measurement mark may be formed on a photosensitive agent on a substrate by exposure, thereby measuring the position of the latent image or developed pattern.

By setting units as exemplified in FIG. 11 at several points on the same measurement mask 7, the effective light source size can be measured for each image height by exposure according to the above-described method. This makes it possible to obtain the effective light source shape as information representing the optical characteristic of the illumination system 1.

[Device Manufacturing Method]

A device manufacturing method according to a preferred embodiment of the present invention is suitable to manufacture, for example, a semiconductor device and liquid crystal device. This method can include a step of transferring the pattern of an original onto a photosensitive agent applied on a substrate using the above-described exposure apparatus, and a step of developing the photosensitive agent. After these steps, other known steps (e.g., etching, resist removal, dicing, bonding, and packaging) are performed, thereby manufacturing devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-256004, filed Sep. 28, 2007, which is hereby incorporated by reference herein in its entirety.

What is claimed is:

1. An exposure apparatus which projects a pattern of a reticle onto a substrate by a projection optical system, thereby exposing the substrate, comprising:
a calculating unit configured to calculate information representing an optical characteristic of the projection optical system, based on a relationship between an amount of defocus from an image plane of the projection optical system and a position of an image formed by the projection optical system.

2. The apparatus according to claim 1, wherein the optical characteristic of the projection optical system includes a numerical aperture (NA) of the projection optical system.

3. The apparatus according to claim 1, wherein the optical characteristic of the projection optical system includes a pupil shape of the projection optical system.

4. The apparatus according to claim 1, wherein the image includes an image of a measurement mark held by a reticle stage.

5. An exposure apparatus which projects a pattern of a reticle onto a substrate by a projection optical system, thereby exposing the substrate, comprising:
a calculating unit configured to calculate information representing an optical characteristic of the projection optical system, based on a relationship between an amount of aberration of the projection optical system and a position of an image formed by the projection optical system.

6. The apparatus according to claim 5, wherein the optical characteristic of the projection optical system includes a numerical aperture (NA) of the projection optical system.

7. The apparatus according to claim 5, wherein the optical characteristic of the projection optical system includes a pupil shape of the projection optical system.

8. The apparatus according to claim 5, wherein the image includes an image of a measurement mark held by a reticle stage.

9. An exposure apparatus which illuminates a reticle by an illumination system, and projects a pattern of the reticle onto a substrate by a projection optical system, thereby exposing the substrate, comprising:
a calculating unit configured to calculate information representing an optical characteristic of the illumination system, based on a relationship between an amount of defocus from an image plane of the projection optical system and a position of an image formed by the projection optical system.

10. The apparatus according to claim 9, wherein the optical characteristic of the illumination system includes a numerical aperture (NA) of the illumination system.

11. The apparatus according to claim 9, wherein the optical characteristic of the illumination system includes a pupil shape of the illumination system.

12. An exposure apparatus which illuminates a reticle by an illumination system, and projects a pattern of the reticle onto a substrate by a projection optical system, thereby exposing the substrate, comprising:
a calculating unit configured to calculate information representing an optical characteristic of the illumination system, based on a relationship between an amount of aberration of the projection optical system and a position of an image formed by the projection optical system.

13. The apparatus according to claim 12, wherein the optical characteristic of the illumination system includes a numerical aperture (NA) of the illumination system.

14. The apparatus according to claim 12, wherein the optical characteristic of the illumination system includes a pupil shape of the illumination system.

15. The apparatus according to claim 12, wherein the image includes an image of a measurement mark held by a reticle stage.

16. A device manufacturing method comprising the steps of:
exposing a substrate using an exposure apparatus defined in claim 1; and
developing the substrate.

17. A device manufacturing method comprising the steps of:
exposing a substrate using an exposure apparatus defined in claim 5; and
developing the substrate.

18. A device manufacturing method comprising the steps of:
exposing a substrate using an exposure apparatus defined in claim 9; and
developing the substrate.

19. A device manufacturing method comprising the steps of:
exposing a substrate using an exposure apparatus defined in claim 12; and
developing the substrate.
